(19) United States
(12) Patent Application Publication
(10) Pub. No.: US 2008/0023872 A1
(43) Pub. Date: Jan. 31, 2008

(54) Process and Device for the Extrusion/Moulding of Thermoplastic Hollow Bodies

(75) Inventor: Bjorn Criel, Merelbeke (Belgique) (BE)

Correspondence Address: OBLON, SPIVAK, MCCLELLAND MAIER & NEUSTADT, P.C., 1940 DUKE STREET, ALEXANDRIA, VA, 22314, US

(73) Assignee: INERGY AUTO. SYSTEMS RESEARCH (SOCIETE ANONYME), Brussels (BE)

(21) Appl. No.: 11/547,848

(22) PCT Filed: Apr. 7, 2005
(86) PCT No.: PCT/EP05/51551

§ 371 Date: Aug. 16, 2007

(30) Foreign Application Priority Data
Apr. 8, 2004 (FR) 04.03731

(51) Int. Cl. B29C 49/42

(52) U.S. Cl. 264/159; 264/294; 425/531; 425/532; 425/534

(57) ABSTRACT

A process and device for extrusion/molding of thermoplastic hollow bodies using at least one extruder and at least two molds and including the extrusion of a flow of material, its cutting into parisons, and the molding of the parisons to produce the hollow body, alternately in the first mold and then in the second mold. The process may work in parallel for certain of its operations. The process and the device are well suited for producing hollow bodies of complex three-dimensional geometry with a high productivity.

The present invention relates to a process for the extrusion/moulding of thermoplastic hollow bodies, making it possible in particular to manufacture a moulded hollow body of complex three-dimensional geometry.

These hollow bodies have many applications. Among these, mention may be made of those in the motor-vehicle field, for example tubings for filling tanks with fuel or with various fluids, such as an engine coolant, fluid for hydraulic brake control systems, windscreen washer or headlight washer fluid, or a refrigerant for air conditioning systems. Another group is also formed by ventilation pipes or pipes for transporting various fluids. These filling tubings and these pipes are positioned, and follow a path that is often determined by the complex shape and often restricted space left free, between the components and various systems making up the vehicle or its engine. As a result, there is a growing need in modern vehicles to be able to fit hollow bodies that are sometimes of large dimensions and often of very complex three-dimensional geometry.

Various known solutions to this problem have been proposed, each offering its particular advantages.

For example, an extrusion/blow moulding process disclosed in Patent EP 1 263 566 is known, this consisting in carrying out, in sequence, the following operations:
a) a tubular parison is extruded in a vertical direction and this flows out downwards under the effect of its own weight;
b) the parison is taken over a certain length before being held by the arm of a mechanical handling device acting as a robot;
c) the parison is deposited by the robot in a preforming tool separate from the robot;
d) the preformed parison is transferred above a lower part of a mould by means of this preforming tool;
e) the parison is deposited by the preforming tool in the lower part of the mould;
f) the mould is closed and the parison is moulded;
g) the mould is opened; and
h) the hollow body is removed from the mould.

This known process makes use of a preforming tool capable of impressing a complex three-dimensional shape on the parison.

However, it has the disadvantage that it does not exploit the possibility of parallel moulding between several moulds.

The object of the invention is to remedy this drawback, while still having the handling flexibility and manufacturing cost advantages of moulding that are associated with the use of a handling robot.

For this purpose, the invention relates to a process for the extrusion/moulding of thermoplastic hollow bodies, using at least one extruder and at least two moulds, in which a tubular flow of molten thermoplastic is extruded through an extrusion head of at least one extruder, the flow of material is cut so as to create parisons, the parisons each being moulded into a hollow body, alternately in the first mould and then in the second mould, each of the moulds comprising moving parts that cannot be positioned beneath the extrusion head, the said process furthermore using a preforming tool and a mechanical handling device, this device being separate from the preforming tool, such that the device takes hold of the parison and deposits it in the preforming tool, this same preforming tool transferring the preformed parison to one or other of the moulds in order to mould a hollow body.

The term “extrusion/moulding” is understood to mean the technique of forming thermoplastic articles comprising a step of extrusion or coextrusion of a monolayer or multilayer flow of molten thermoplastic or extrudate, a step of separating the extrudate into individual preforms and a step of moulding these preforms. Advantageously, the moulding is carried out by blow moulding inside a closed mould. In the case of articles in the form of hollow bodies, the performs are parisons of closed cross section, in particular tubular parisons of cross section with no salient angles. More generally, the cross section of these parisons is circular or elliptical.

Within the context of this invention, the expression “extrusion of a parison” will be used, improperly, to denote “the extrusion of a tubular flow of molten thermoplastic”.

The term “hollow body” denotes here any structure whose surface has at least one empty or concave part. The term “hollow body” also denotes tubes, bottles or tanks defining a closed or non-closed volume. In particular, the process according to the invention is very suitable for the production of hollow bodies having the shape of a tube or tubing.

The process according to the invention relates to the production of thermoplastic hollow bodies, that is to say made of a material comprising at least one synthetic resin polymer.

All types of thermoplastics may be suitable. Very suitable plastics fall within the category of thermoplastics.

The term “thermoplastic” denotes any thermoplastic polymer, including thermoplastic elastomers, as well as blends thereof. The term “polymer” denotes both homopolymers and copolymers (especially binary or ternary copolymers). Examples of such copolymers are, non-limitingly: random copolymers, linear block copolymers, other block copolymers, and graft copolymers.

Any type of thermoplastic polymer or copolymer, the melting point of which is below the decomposition temperature, is suitable. Thermoplastics, which have a melting range spread over at least 10° Celsius, are particularly suitable. Examples of such materials include those that exhibit polydispersion in their molecular weight.

In particular, polyolefins, grafted polyolefins, thermoplastic polyesters, polyketones, polyamides and copolymers thereof may be used.

One polymer often employed is polyethylene. Excellent results have been obtained with high-density polyethylene (HDPE).

One copolymer often used is ethylene-vinyl alcohol copolymer (EVOH). A blend of polymers or copolymers may also be used, as may a blend of polymeric materials with inorganic, organic and/or natural fillers such as, for example, but not limitingly: carbon, salts and other inorganic derivatives, and natural or polymeric fibres.

It is also possible to use multilayer structures consisting of stacked layers bonded together, comprising at least one of the abovementioned polymers or copolymers. Such multilayer structures may be obtained using a coextrusion head or by a technique of completely or partly covering a substrate layer with one or more other layers. An example of the covering technique is the spraying of a thermoplastic onto the substrate layer by spray coating.

The expression “extrusion of a tubular parison” denotes the process whereby a tubular flow of at least one molten and homogenized thermoplastic flows through a die in an extrusion machine, the head of which terminates in the die, in order to obtain a parison of closed cross section, particularly of circular or elliptical cross section. When the parison has a multilayer structure, several extruders are used—one per layer present in the multilayer structure.

The extrusion process may be continuous. As a variant, it may also be an accumulator extrusion process, in which molten thermoplastic is accumulated in a suitable reservoir placed on the extrusion machine. This accumulator extrusion process advantageously allows extrusion of the parison through the die to be rapidly stopped and restarted and allows very flexible adaptation to the extrusion/moulding cycles. The accumulator extrusion process is particularly suitable for fluid thermoplastic resins that have a tendency to extend greatly under their own weight during the expulsion from the extruder. It is also possible, through this accumulation process, to produce parisons having, over their length, portions composed of different materials. This technique is called sequential coextrusion, as opposed to conventional continuous coextrusion, resulting in concentric multilayer structures.

The process according to the invention is very suitable when it is required to combine the use of a suitable number of extruders with a number of moulding devices such that the respective rates of each extrusion and moulding unit are respected and interact in a flexible manner so as to increase productivity. For this purpose, the flow of extruded material is cut so as to create parisons that are each moulded into a hollow body alternately in the first mould and then in the second mould, and so on depending on the number of moulds available.

The moulds comprise moving parts, in particular a lower part, which cannot be positioned beneath the extrusion head. It is therefore necessary for the extruded parison not to be collected directly in a moving part of a mould but only after an intermediate transfer step.

According to the invention, the parison is taken hold of by a mechanical handling tool acting as robot. The object of this operation is to take a certain length of the flow of extruded molten material, in the form of parisons. This may be accomplished, for example, by periodically cutting the flow of extruded material using a cutter in a plane perpendicular to the direction in which it is flowing, followed by the taking of the parison thus obtained by the gripper member of the robot. Another technique is to cut the flow of extruded material using the vertical movement of the central core of the extrusion head (normally used to vary the thickness of the parison during its expulsion) and then, as soon as it is cut, to take hold of the parison by means of the robot's gripper member. Another possible technique is also, for example, to pinch off and detach, by means of the gripper member of the robot itself, in the close proximity to the die, a given length of the material in the flowing situation.

The robot may be controlled manually by an operator. It may also, for at least some of its movements, be controlled by a control and regulation machine. The latter may act, in open loop or closed loop, through the action of a prerecorded computer program and/or may modify its actions in response to signals coming from sensors that detect various situations arising in particular from the extrusion/moulding process or from the extruded flow of material itself.

If necessary, the robot may be made of any material compatible with parisons whose temperature is intermediate between the ambient temperature and the melting point of the thermoplastic of which the parison is made. A metallic material is preferred. Particularly preferred are light metals and light metal alloys, such as aluminium and its alloys. It is also possible to provide a surface treatment of the robot's gripper member in order to prevent the parison from sticking on the surface of the gripper member. The surface treatment may consist, for example, of a coating produced using one of the techniques known to those skilled in the art. It is also possible for the robot's gripper member to be cooled so as to guarantee better tension of the parison.

Furthermore, according to the invention the mechanical handling device deposits the parison in a preforming tool, which is separate from the mechanical handling tool. While the mechanical handling device is transferring the parison from the extrusion head to the preforming tool, the position of the parison is approximately vertical. Preferably, the transfer movement itself (between the moment when the device takes the parison and the moment when it deposits it in the preforming tool) is strictly vertical (i.e. the preforming tool lies beneath the extrusion head). By preceding in this way it is possible to prevent the parison from swinging and deforming excessively.

The function of the preforming tool is to modify the geometry of the extruded parison before it enters the mould where it will be moulded.

This preforming tool is an object that can take various forms. It is advantageous for it to have, in parts intended to come into direct contact with the parison, a form that prefigures the final form that the hollow body that it is desired to produce must have, so as to give the parison, which is still soft because its temperature is close to that which it had in line with the extrusion die, the desired preform. The preforming tool may thus have a plane surface or a surface that is curved in a defined conformation, depending on the desired shape of the parison before it is introduced into the mould. This property is particularly useful when it is intended to produce three-dimensional preform parisons. It is particularly advantageous for the production of hollow bodies of complex three-dimensional geometry.

An example of such a preforming tool is that of one article in the form of a straight valley or one having several raked curves, the bottom of which is flat or in the form of a surface regulated by straight lines perpendicular to the axis of the parison. The walls of the valley may consist of a solid surface, for example a flat surface. They may on the contrary be formed by an association of elements that cooperate with one another so as to leave gaps in the walls. It is thus possible to have walls in the form of a trellis or mesh, or even simply an alignment of straight or curved rods spaced apart more or less regularly.

It is advantageous for the bottom of such a preforming tool on which the parison rests to be designed so as to be able to attract upon command so as to deposit the preformed parison out of the preforming tool, under its own weight.

It is also advantageous to provide the preforming tool with a gripper that helps to deposit the parison into it. One way of doing this in practice consists in choosing a rotary gripper, that is to say one capable of taking hold of the parison and performing a rotation in order to bring it into the axis of the tool. In the aforementioned variant, in which the parison is in a vertical position, the rotary gripper preferably performs a 90° rotation between a position approximately perpendicular to the tool (in which it takes hold of the parison via the bottom) and a position approximately parallel to the latter (in which it aligns the bottom of the parison with the rest of it). Through its movement, this rotary gripper accompanies the parison during the phase of depositing it in the preforming tool. In addition, this rotary gripper deals the parison. Thus, the air inside this parison heats up and expands, giving the parison stability and preventing it from collapsing in the tool.

The preforming tool may be made of any material compatible with the parisons, as mentioned above with regard to the material of the robot. Preferably, it comprises, at least on the surface, a material that prevents the parison from sticking. Such a material may be a resin, preferably fluororesin or a silicone resin.

The preforming tool is furthermore capable of transferring the preformed parison to one or other of the moulds used by the process, so as to mould a hollow body.

The preforming tool may, like the robot, be manually controlled by an operator or may be regulated, as described above.

The process of the invention comprises, in one particular method of implementation, a certain number of steps performed in a cycle, that is to say a particular sequence of successive steps.

According to this particular method of implementing the invention, the tubular flow of molten thermoplastic is extruded through the extrusion head in a vertical direction and it flows out downwards under its own weight, until a useful length has been obtained. Next, a parison corresponding to the useful length of the flow of extruded material is cut off then taken hold of and transferred vertically by the mechanical holding device.

As indicated above, the preforming tool preferably has a base position defined in such a way that the first point of contact between the parison and the preforming tool lies vertically in line with the extrusion head. The deposition of the parison in the preforming tool eliminates any horizontal transfer of the parison, that is to say a step during which the parison might deform and therefore give the blow-moulded article a poor thickness distribution.

In this sequence of steps, the preformed parison is transferred by the preforming tool and is then deposited in the lower part of a first mould. For this purpose, the preforming tool is provided with movement means so that it can be positioned above the bottom part of an open mould that includes a cavity having a suitable shape intended to receive the parison.

The preforming tool may for example be inserted into the open space lying between the two parts of a mould in the open position.

The parison may be deposited in the mould by any suitable means, provided that it preserves the preform impressed on the parison by the preforming tool.

It is possible, for example, to turn the preforming tool upside down above the mould so as to deposit the parison in the latter.

Another means is also to employ a mechanical handling robot for taking hold of the preformed parison and depositing it in the lower mould part, without modifying its geometry.

A preferred means consists in using a preforming tool provided with a bottom that can be retracted upon command, so as to be able to deposit the parison very simply in the lower part of the mould through the open bottom of the correctly positioned preforming tool. This manner of proceeding advantageously allows the tool to be brought close to the cavity of the lower part of the mould and avoids any deformation of the geometry of the parison while it is being deposited in the mould.

When the preformed parison is in place in the lower part of the first mould, a movement is impressed on said lower part so that the parison is completely away from the preforming tool. This intermediate step avoids any risk of the parison being damaged when disengaging the preforming tool.

Next, the first mould is closed by the lower part of the mould pressing against the upper part. The preformed parison is then moulded, for example by the injection of a blowing fluid into the parison inside the closed mould. This injection may be carried out, for example, by introducing, into the closed mould, at least one hollow needle that firstly pierces the parison at one of its ends, and then the blowing fluid is forced through the needle under sufficient pressure to apply the walls of the parison against the entire surface of the cavity of the mould. The blowing may also advantageously be carried out via two needles, each located at one end of the blow-moulded article. The flow of the blowing fluid between the two orifices then significantly increases the effectiveness of the cooling. The blowing fluid may be a gas, a liquid or a dispersion of at least one liquid in a gas. As pressurized fluid, compressed air has given good results.

It is also possible to use a pressurized flushing fluid comprising a reactive gas. Such a reactive gas may be fluorine.

It is also possible to use an inert gas, such as nitrogen. A mixture of various gases may also be used, in particular a mixture containing at least two of the abovementioned gases. Among liquids, it may be advantageous to use water. A fluid that has led in particular to excellent results is a dispersion or spray of water in compressed air.

It is also possible to perform an additional surface treatment of the hollow body in the mould. In this case, it is possible to use, for example, a reactive gas such as fluorine.

After moulding, the first mould is opened and the hollow body produced is removed.

To improve the productivity, in particular by reducing the cycle time, a sequence of steps is advantageously carried out in parallel, that is to say while the first parison is being moulded and before the first mould is opened.

The preforming tool returns to the base position so as to receive a new parison. This is obtained by extruding the flow of molten material, the parison then being taken hold of by the arm of the robot. The latter then deposits the parison in the preforming tool.

Thereafter the preforming tool moves towards a mould different from that that has moulded the first parison and the succession of steps described above is repeated in the same way for this second mould, namely deposition of the new parison by the preforming tool in the lower part of the second mould, disengagement of the parison from the preforming tool by movement of the lower part of the mould, closure of the mould, and moulding of the new parison.

Once the preforming tool has disengaged from the second mould, it returns to its base position to receive a third parison. Thereafter, the cycle described first is repeated with the new parison for the first mould.

The preforming tool moves alternately between the two moulds, allowing operations to be carried out in parallel.

The invention may advantageously be extended to a set of moulds comprising more than two moulds so as to further increase the productivity and reduce the cycle time even more. This is because the moulding step may in certain cases be much longer than the parison extrusion, cutting and transfer steps performed by means of the preforming tool. Such a process advantageously comprises the following steps:
a) a tubular flow of molten thermoplastic is extruded through the extrusion head in a vertical direction and it flows out downwards under the effect of its own weight, until a useful length has been obtained;
b) a parison (n) corresponding to the useful length of the flow of extruded material is cut off, then taken hold of and transferred vertically by the mechanical handling device;
c) the parison (n) is deposited by the device in the preforming tool in order to obtain a preformed parison (n);
d) the first mould is opened and a hollow body (n−1) moulded during the preceding cycle of steps is removed from the first mould;
e) the preformed parison (n) is transferred by means of the preforming tool above a lower part of the first mould;
f) the preformed parison (n) is deposited by the preforming tool in the lower part of the first mould;
g) the preforming tool is moved away from the closure zone of the first mould and sent back to the base position beneath the extrusion head;
h) the first mould is closed and the preformed parison (n) is moulded into a hollow body (n), during step h), a sequence of steps comprising:
   1) the extrusion/moulding of a hollow body (n+1) from a parison (n+1), the −extrusion of which was started after the parison (n) was cut, by repeating steps a) to h) with the second mould; and
   2) the extrusion of a parison (n+2), the extrusion of which was started after the parison (n+1) was cut,
      being carried out, the said sequence of steps being such that, at the end of step 1), the preforming tool returns to the base position so as to receive the parison (n+2), steps a) to h) then being repeated on the parison (n+2).

All of the operations of the process may be controlled, sequenced and/or regulated in open or closed loop, as already mentioned above with regard to the robot and the preforming tool. Closed-loop regulation is preferred.

According to another particular method of implementing the process according to the invention, an extraction device for extracting the moulded hollow body is actuated in order to make it drop into an extraction device.

The nature of the constituent material of the receiving device is chosen so as to remain compatible with the transportation of the hollow bodies at the temperature at which they leave the mould.

Materials similar to those described above for the preforming tool are also very suitable for producing the receiving device.

An example of an extraction device comprises the penetration of at least one small thrust actuator inside the volume of the upper mould cavity so as to push the hollow body out of this cavity and, by being loosened, to cause it drop out of the cavity.

In another particular method of implementing the process according to the invention, the preforming tool may be provided with a temperature conditioning system. This makes it possible to prevent excessive cooling of the parison and also any thermal non-uniformity of the latter.

Advantageously, the process according to the invention is very suitable for the production of thermoplastic tubings intended for transporting fuel. In particular, it is very suitable for the production of tubings for filling fuel tanks. It is most particularly advantageous when these filling tubings have to have a complex three-dimensional shape.

In another particular method of implementation, the process according to the invention may also be extended to tubings comprising two ducts (for example a filling duct and a venting duct in the case of fuel tanks).

The invention also relates to a device for the extrusion/moulding of hollow bodies that comprises at least one extruder, one extrusion head and at least two moulds used alternately, each of the moulds comprising moving parts that cannot be positioned beneath the extrusion head, the device furthermore including a preforming tool and a mechanical handling device, this device being separate from the preforming tool.

As mentioned above, the preforming tool is advantageously provided with a rotary gripper that can take hold of the parison by the bottom and perform a 90° rotation between a position approximately perpendicular to the tool and a position approximately parallel to the latter.

When the parison is of multilayer structure, several extruders are used, one per layer present in the multilayer structure.

In the description of this device given here, the terms “extrusion/moulding”, “hollow body”, “parison”, “thermoplastic”, “mould”, “blow moulding”, “robot” and “preforming tool” have the same meaning as those given above in respect of the process.

The device preferably includes a mechanical handling device, provided with an arm, and a preforming tool separate from the mechanical handling device, acting as robot.

Preferably, the preforming tool is provided with means for transferring the preformed parison into a part of an open first mould. These preforming tool transfer means are the same as those already described above in respect of the process.

A preferred embodiment of the device according to the invention comprises a robot, a preforming tool and mould parts that can move at least partly at the same time.

Another advantageous embodiment of the device according to the invention is one in which it is provided with a device for receiving the hollow body when the mould opens.

This receiving device is similar to that described above in respect of the process.

The device according to the invention is very suitable for the production of extruded/moulded hollow bodies used as fuel tubings. Such tubings are, for example, the fuel transport lines or ducts in motor vehicles with an internal combustion engine. They may also be fuel filling tubings mounted on tanks intended to contain these fuels. The device according to the invention is most particularly suitable when the tubings have complex three-dimensional shapes.

### EXAMPLE

The example that follows is given by way of illustration of the invention, without wishing to limit its scope.

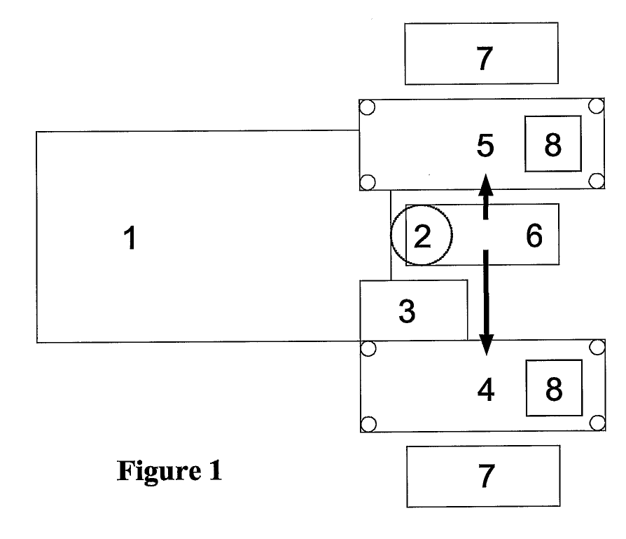

In one specific method of implementing the process, the device described in FIG. 1 is used. A multilayer extrusion head (2) is fed by the extruder (1). After a useful length of a flow of molten material has been expelled, a parison is cut off and then taken hold of in its upper part by the robot (3), which deposits it in the preforming tool (6). After the deposition, the preforming tool is introduced by a horizontal movement into a moulding machine so as to place the parison in the lower part of the blow moulding mould (4). At the end of the cycle, the article, maintained in the upper cavity while the mould (4) is being opened, is extracted by means of an extraction device (8) (this is in general an extractor inside the mould) and is received in the receiving device (7).

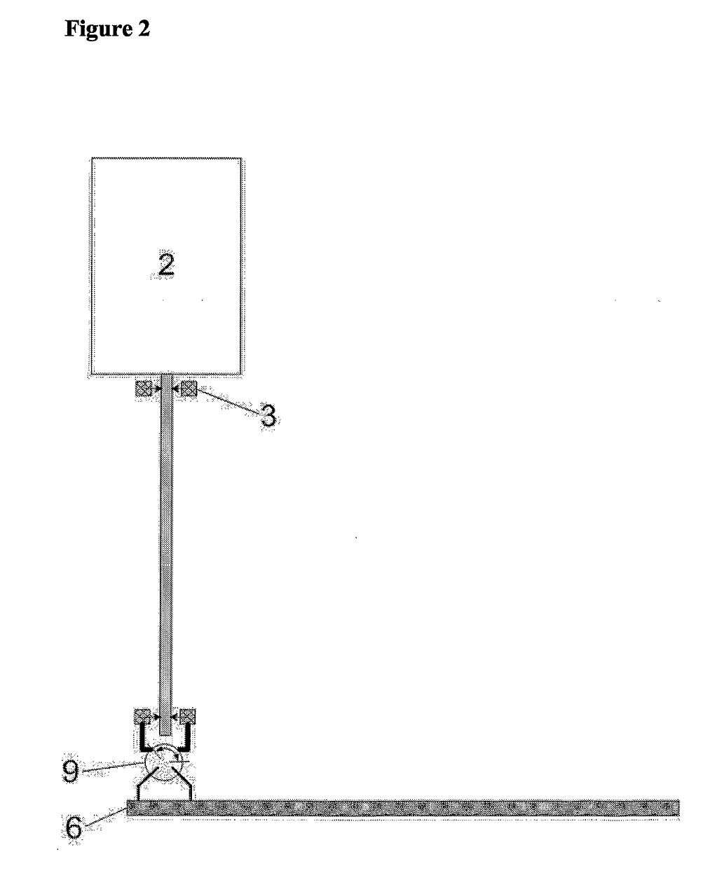

While the parison is being moulded in the mould (4), the preforming tool (6) returns to its base position in order to receive a new parison that the robot (3) is holding and deposits on the preforming tool (6) before the latter transfers the preformed parison to a second mould (5). The transfer of the new parison into the mould (5) takes place only when the latter is open, the hollow body moulded during the preceding cycle being extracted from the upper cavity of the mould (5). After the second parison has been deposited in the mould (5), the preforming tool (6) again returns to its base position in order to receive another parison, which will follow the same manufacturing cycle as that described in the case of the first parison. The preforming tool (6) used in FIG. 1 is provided with a rotary gripper (9), this being illustrated in FIG. 2. This gripper grips the bottom (lower end) of the parison when the latter is brought in by the robot (3) and, while the robot is moving and depositing the parison in the tool (6), the said gripper takes hold of this end while performing a 90° rotation (in the direction indicated by the arrow) in order to accompany the deposition movement. Without this rotation movement, the end held by the gripper (9) could not be aligned with the rest of the parison and a shape heterogeneity could remain in the final hollow body moulded since, if this movement were not present, a small end of the parison would remain substantially vertical, whereas most of the parison is positioned so as to be approximately horizontal. This (the small vertical end) makes it markedly more difficult to transfer the parison from the preforming tool into the lower half-mould.

1-12. (canceled)

13. A process for extrusion/molding of thermoplastic hollow bodies, using at least one extruder and at least first and second molds, comprising:
extruding a flow of at least one molten thermoplastic through an extrusion head of the extruder;
cutting the flow of material so as to create parisons;
molding each of the parisons into a hollow body, alternately in the first mold and then in the second mold, each of the molds including moving parts that cannot be positioned beneath the extrusion head; and
using a preforming tool and a mechanical handling device, the handling device being separate from the preforming tool, such that the handling device takes hold of the parison and deposits the parison in the preforming tool, the same preforming tool transferring the preformed parison to one or other of the molds to mold a hollow body.

14. The process according to claim 13, wherein the preforming tool includes a rotary gripper that takes hold of the parison via its bottom and accompanies its deposition in the preforming tool, preforming a 90° rotation between a position approximately perpendicular to the preforming tool and a position approximately parallel to the preforming tool.

15. The process according to claim 13, comprising a cycle of:
a) extruding the tubular flow of molten thermoplastic through the extrusion head in a vertical direction to flow out downwards under effect of its own weight, until a useful length has been obtained;
b) cutting off a parison corresponding to the useful length of the flow of extruded material, then taking hold of and transferring the parison vertically by the mechanical handling device;
c) depositing the parison by the handling device in the preforming tool to obtain a preformed parison;
d) opening the first mold and a remaining hollow body molded during the preceding cycle of operations from the first mold;
e) transferring the preformed parison by the preforming tool above a lower part of the first mold;
f) depositing the preformed parison by the preforming tool in the lower part of the first mold;
g) moving the preforming tool away from a closure zone of the first mold and sending the preforming tool back to a base position beneath the extrusion head;
h) closing the first mold and molding the preformed parison into a hollow body;
the closing h) comprising:
1) extrusion/molding of a next hollow body from a next parison, the extrusion of which was started after the parison was cut, by repeating operations a) to h) with the second mold; and
2) extrusion of a next further parison, the extrusion of which was started after the next parison was cut, being carried out, the sequence of operation being such that, at the end of 1), the preforming tool returns to the base position so as to receive the next further parison, a) to h) then being repeated on the next further parison.

16. The process according to claim 13, wherein the preforming tool comprises, at least on the surface, a material that prevents the parison from sticking.

17. The process according to claim 13, wherein an extraction device for extracting the hollow body is actuated to drop under gravity into a receiving device.

18. The process according to claim 13, wherein the preforming tool is temperature-conditioned.

19. The process according to claim 13, wherein the hollow bodies that are extruded and molded are tubings for fuel.

20. A hollow body extrusion/molding device for carrying out the process according to claim 13, comprising:
at least one extruder,
one extrusion head;
at least first and second molds used alternately, each of the molds comprising moving parts that cannot be positioned beneath the extrusion head; and
a mechanical handling device, provided with an arm, and a preforming tool separate from the mechanical handling device acting as a robot.

21. The device according to claim 20, wherein the preforming tool includes a rotary gripper that can take hold of the parison by the bottom and preform a 90° rotation between a position approximately perpendicular to the tool and a position approximately parallel to the tool.

22. The device according to claim 20, wherein the preforming tool includes means for transferring the preformed parison into a part of at least one open mold.

23. The device according to claim 20, wherein the mechanical handling device, the preforming tool, and the parts of at least one mold can move at a same time.

24. The device according to claim 20, further comprising a receiving device for receiving a molded hollow body when the mold is opened.
